(19) United States
(12) Patent Application Publication
(10) Pub. No.: US 2005/0162651 A1
(43) Pub. Date: Jul. 28, 2005

(54) Automatic optical inspection of components using a shadow projection threshold for a data storage device

(75) Inventors: Ching Tong Sim, Singapore (SG); Rory S. Limqueco, Singapore (SG); Jee Suan Kwok, Singapore (SG); YewChoon Chia, Singapore (SG)

Correspondence Address: SeagateTechnology LLC;Intellectual Property - OKM178, 10321 West Reno, Oklahoma City, OK, 73127-7140, US

(73) Assignee: Seagate Technology LLC, Scotts Valley, CA (US)

(21) Appl. No.: 10/763,827

(22) Filed: Jan. 22, 2004

(51) Int. Cl. G01B 11/00

(52) U.S. Cl. 356/394

(57) ABSTRACT

A method and apparatus for determining compliance of a component of a printed circuit board assembly that includes determining the presence or non-presence of a component on a printed circuit board assembly (PCBA), by comparing electronically a reflected light intensity transition region with a predetermined reflected light intensity transition region threshold, using a computer controlled vision system operating under component compliance software. Wherein the reflected light intensity transition region is an intensity of light reflected off a meniscus of a solder joint formed between the component and a solder pad referred to as a shadow projection. The shadow projection is characterized as adhering or not adhering to the threshold, and determination of component compliance is based on the characterization of the shadow projection. If the component is found compliant, the PCBA is identified as compliant. If the component is found non-compliant, the PCBA is identified as non-compliant.

### FIELD OF THE INVENTION

This invention relates generally to the field of magnetic data storage devices, and more particularly, but not by way of limitation, to comparing electronically a reflected light intensity transition region with a predetermined reflected light intensity transition region threshold to determine compliance of a component.

### BACKGROUND

One key component of any computer system is a device, [such as a data storage device (DSD)] to store data. The most basic parts of a DSD are an information storage disc that is rotated, an actuator that moves a read/write head to various locations over the substantially concentric data tracks of a disc, and electrical circuitry used for encoding data so that the data can be successfully retrieved and written to the disc surface. A microprocessor controls most of the operations of the disc drive including exchanging data between the computer system and the DSD.

Among the challenges associated with DSD assembly processes are cost effective techniques for assuring mechanical compliance of components of a printed circuit board assembly supporting the DSD. As the physical size of components utilized by DSD's continue to reduce in size, difficulties compound with incorporation of manual inspection techniques, for assuring mechanical compliance of the components. Additionally, as components from multiple suppliers are utilized to attain production demands, problems arise with maintaining component configuration libraries utilized by automated pattern recognition techniques for compliance certification due to variations in physical configuration, i.e. coloring, and shape, between suppliers.

As such, challenges remain and a need persists for cost effective techniques for assuring mechanical compliance of electrical components utilized by electrical devices, including DSDs.

### SUMMARY OF THE INVENTION

In accordance with preferred embodiments, a method, apparatus, and combination are provided for determining compliance of a component of a printed circuit board assembly (PCBA). The method preferably incorporates an electronic comparison of a reflected light intensity transition region (also referred to as a shadow projection) with a predetermined reflected light intensity transition region threshold to determine compliance of the component of a printed circuit board of a PCBA.

In one aspect, a status (i.e., presence or non-presence) of the component at a predetermined component site of the printed circuit board assembly is ascertained, and the reflected light intensity transition region is an intensity of light preferentially reflected off a meniscus of a solder joint formed between the component and an associated solder pad of the printed circuit board assembly. The intensity of light reflected off the meniscus is preferably characterized as adhering or non-adhering to the threshold, and compliance of the component connected to the printed circuit board assembly based on the characterization of the adherence of the intensity of light reflected off the meniscus to the threshold.

In another aspect, an apparatus for determining compliance of a component connected to a PCBA includes: a light source illuminating the component of the PCBA as well as the solder joint connecting the component to the PCBA; a processor controlled vision system responsive to the light source; and an alignment apparatus controlled by a processor supporting the vision system. The alignment apparatus aligns the vision system relative to the solder joint and the component.

The compliant determination apparatus further includes decision software programmed into the processor responsive to the vision system, which determines compliance of the component connected to the printed circuit board assembly based on the shadow projection of the solder joint to determine compliance of the printed circuit board assembly.

A further aspect of the preferred embodiments of the present invention includes, a data storage device having a head-disc assembly and a compliant printed circuit board assembly attached to the head-disc assembly. Compliance of the printed circuit board assembly is determined by the compliance determination apparatus executing the method, for determining compliance of the component connected to the printed circuit board assembly.

Although a data storage device has been selected as an application environment for illustrative purposes to enhance an understanding by any person skilled in the art of the subject matter considered by the inventors as their invention, the invention is not limited to the data storage device application environment, and no such limitations are imputed to the invention.

These and various other features and advantages that characterize the claimed invention will be apparent upon reading the following detailed description and upon review of the associated drawings.

### BRIEF DESCRIPTION OF THE DRAWINGS

FIG. 1 is a partial cut-away top plan view of a data storage device (DSD) that incorporates a compliant printed circuit board assembly (PCBA) determined compliant by a compliance determination apparatus executing a method for determining compliance of the PCBA.

FIG. 2 is a partial cut-away top plan view of a component of the PCBA mounted on the PCBA of FIG. 1.

FIG. 3 is a partial cut-away top plan view of the component of the PCBA showing shadow projections of a solder joint of the component of the PCBA of FIG.1.

FIG. 4 is a partial cross-sectional elevational view of a solder pad of the PCBA of FIG. 1 relative to a lens capturing light reflected from the solder pad.

FIG. 5 is a partial cross-sectional elevational view of a solder joint on the solder pad of the PCBA of FIG. 1 relative to a lens capturing light reflected from the solder joint.

FIG. 6 is an elevational view of a minimum shadow width used as a threshold for comparing the captured light from the solder pad of FIG. 4, and the solder joint of FIG. 5.

FIG. 7 is a plot of varying intensity of light reflected off the solder pad of FIG. 4, the solder joint of FIG. 5, and the component of FIG. 2.

FIG. 8 is a partial cut-away elevational view of a compliance determination apparatus for use in determining compliance of the component of FIG. 2.

FIG. 9 is a partial cross-sectional elevational view of the component of FIG. 2 in compliance.

FIG. 10 is a partial cross-sectional elevational view of the component of FIG. 2 in non-compliance.

FIG. 11 is a partial cut-away top plan view of the component of the PCBA mounted on the PCBA and a dummy component site provided by the PCBA of FIG. 1 for future use.

FIG. 12 is a flow diagram showing steps for comparing electronically a reflected light intensity transition region with a predetermined reflected light intensity transition region threshold to determine compliance of the component of FIG. 2 to determine compliance of the PCBA of FIG. 1.

### DETAILED DESCRIPTION

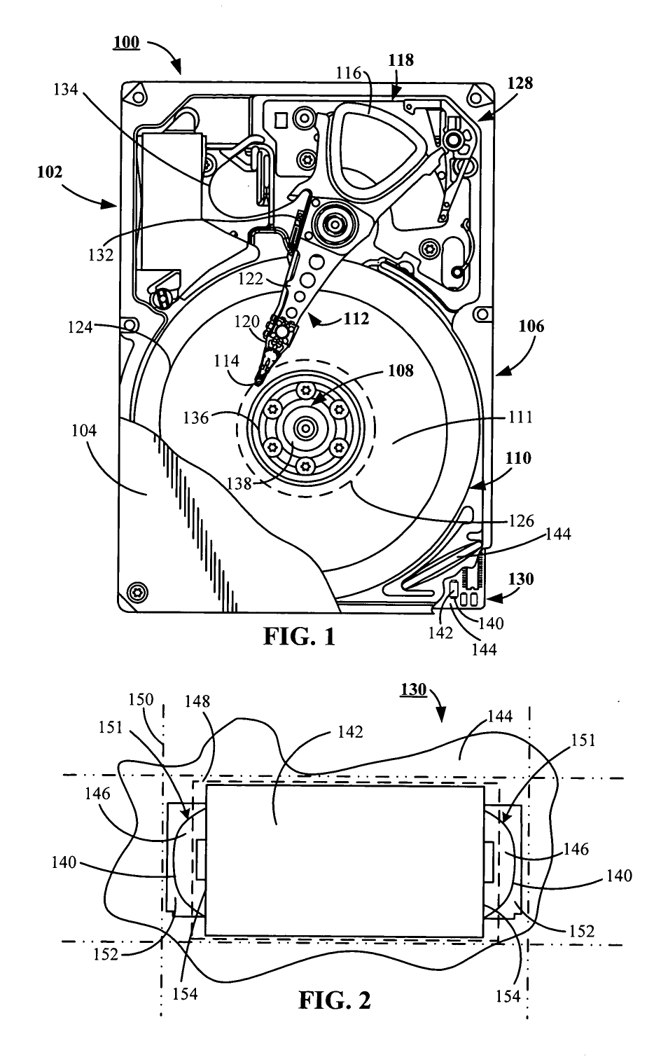

Referring now to the drawings, FIG. 1 provides a top plan view of a data storage device (DSD) 100. The DSD 100 includes a base deck 102 cooperating with a top cover 104 (shown in partial cut-away) to form a sealed housing for a mechanical portion of the DSD 100, referred to as a head-disc assembly (HDA) 106.

A spindle motor assembly (motor) 108 rotates a number of data storage discs (media) 110 with a magnetic recording surface (surfaces) 111 at a substantially constant operational speed. An actuator assembly 112 supports a number of read/write heads (heads) 114. The heads 114 are used for data exchange operations with the surfaces 111. Upon applying a current to a coil 116 of a voice coil motor (VCM) 118, the actuator 112, which is attached to the coil 116, responds by rotating the heads 114 to a position adjacent the surfaces 111. That is, the heads 114 positioned into a data exchange relationship adjacent the surfaces 111 when current is applied to a coil 116 of a voice coil motor (VCM) 118.

A head suspension 120 provides a predetermined spring force on the head 114 to maintain the proper data exchange relationship between the head 114 and the media 110 during operation of the DSD 100. Additionally, the head suspension 120 serves to connect the head 114 with an actuator arm 122 of the actuator 112.

During operation of the DSD 100, the actuator 112 moves the heads 114 into the data exchange relationship with the media 110, i.e., the actuator 112 moves the heads to data tracks 124 on the surfaces 111 to write data to and read data from the media 110. When the DSD 100 is deactivated, the actuator 112 positions the heads 114 adjacent a home position 126 and the actuator 112 is confined by latching a toggle latch 128.

Command, control, and interface electronics for the DSD 100 are provided on a printed circuit board assembly (PCBA) 130 mounted to the HDA 106. During data transfer operations, a preamplifier/driver (preamp) 132 attached to a flex circuit 134 conditions read/write signals conducted by the flex circuit 134 between the PCBA 130 and the heads 114.

In a preferred embodiment, the media 110 is clamped by a disc clamp 136 adjacent a motor hub 138 of the motor 108. The disc clamp 136 assures that the media 110 remains in a fixed position, relative to the motor hub 138, while the motor 108 rotates the motor hub during operation of the DSD 100.

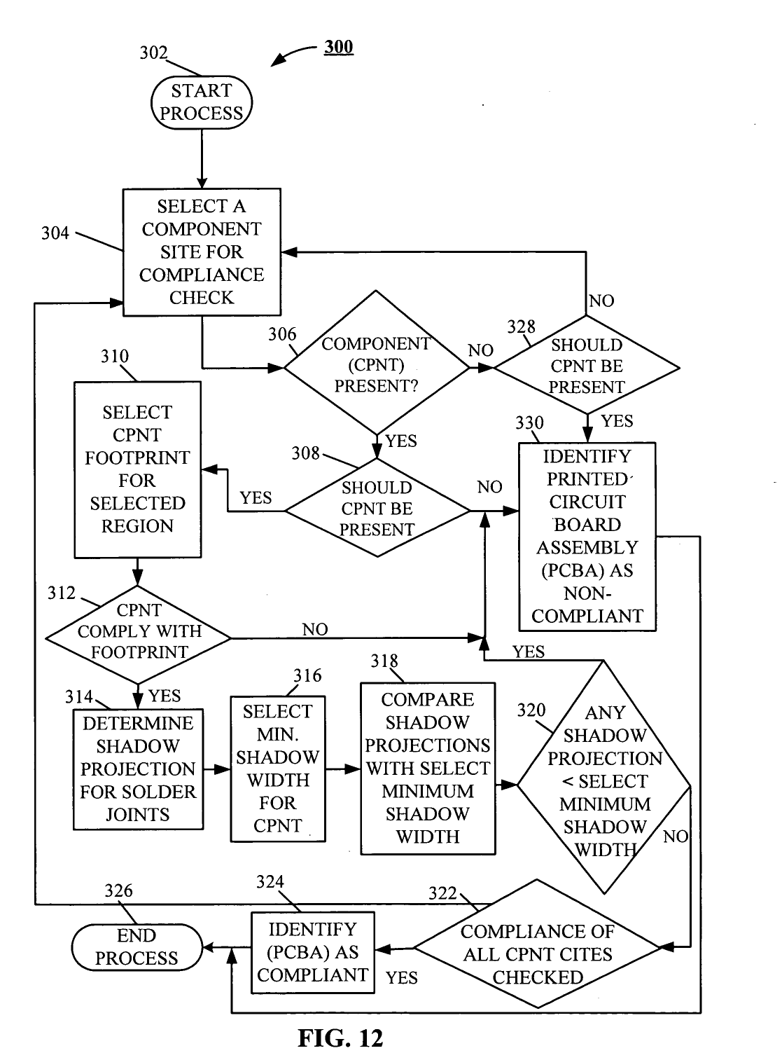

One aspect of the present invention includes a method (covered in detail during the discussion of FIG. 12), for determining mechanical compliance of a solder joint 140 of a component 142 connected to a printed circuit board (board) 144 of the PCBA 130 that improves the accuracy of detecting non-complying chip components, e.g. inductors, tantalum capacitors and diodes, by directing an automated inspection of each solder joint 140 between the chip components and the board 144.

It will be noted that, for the purpose of enhancing and heightened an understanding of the present invention, chip components, e.g. inductors, tantalum capacitors and diodes, have been elected as components for use in presenting the present invention to one skilled in the art. However, as will be readily recognized by one skilled in the art, application of the present invention goes beyond chip components, and as such, utilization of a chip component as a focus for discussion of the present invention is for illustrative purposes only and does not and cannot impose limitations on the present invention.

FIG. 2 shows a meniscus 146 of the solder joint 140, the measurement of which is useful in an application of a preferred embodiment of the present invention. Of further use in a preferred embodiment is a component footprint 148 (illustrated by dashed lines), a component site 150 (illustrated by broken lines), which defines a region on the board 144 that each solder pad 152 corresponding to a lead of the component 142 resides to facilitate a solder joint connection 153 between the solder joint 140 and the board 144.

The component site 150 is used during a determination of a status of the component 142 within the component site 150. That is, whether a component should be present or not. If a component should be present on the board 144 and is not present, the PCBA 130 is identified as non-compliant. If a component should not be present on the board 144 and is present, the PCBA 130 is identified as non-compliant.

If a component should be present on the board 144 in the region of the board identified by the component site 150 and a component is present, a determination is made whether or not the component present in the component site 150 conforms to the component footprint 148. If the component conforms to the component footprint 148, the PCBA 130 is identified as compliant. If the component fails to conform to the component footprint 148, the PCBA 130 is identified as non-compliant.

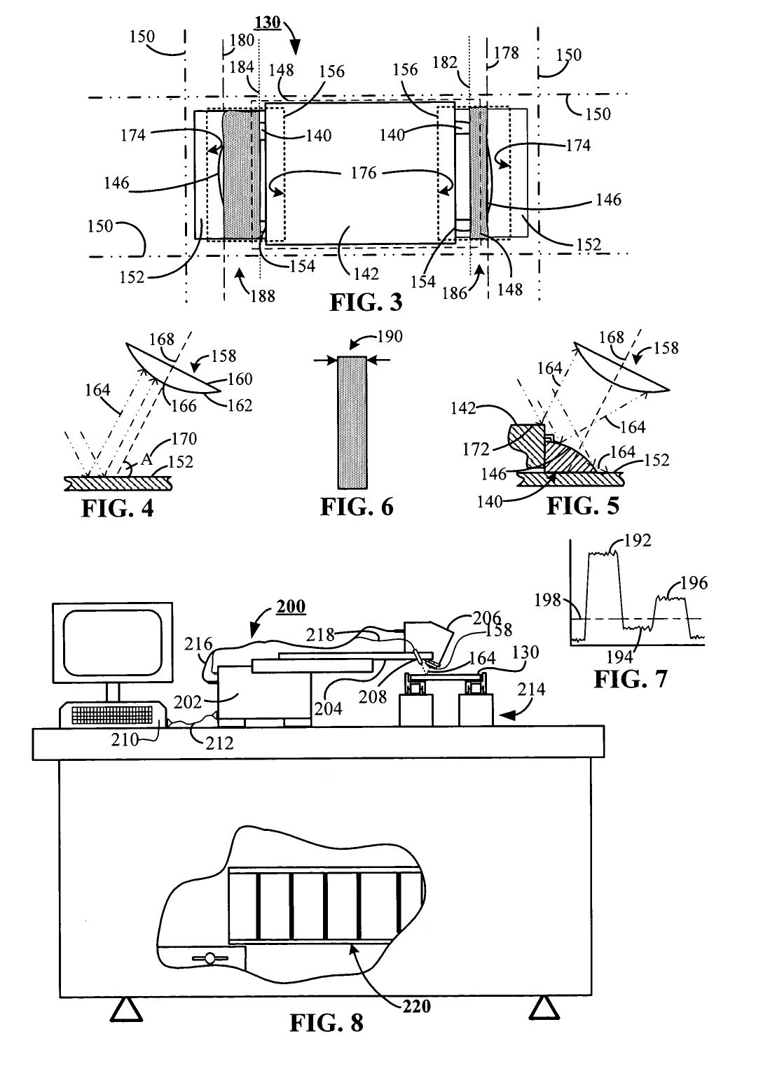

FIG. 3 shows a component edge 154 inboard from the meniscus 146, relative to the solder pad 152. A solder pad search window 156 (illustrated by dotted lines) is used by a preferred embodiment of the present invention to analyze changes in intensity of light reflected off of the solder pad 152, and the meniscus 146 in the component edge 154. Variations in the intensity of the reflected light are analyzed to form a basis of determining mechanical compliance of the component 142.

FIG. 4 shows a lens 158 with a flat surface 160 and curved surface 162 used in a preferred embodiment of the present invention to capture reflected light 164. The curved surface 162 includes a center of curvature 166, through which a line 168 passes normal to the flat surface 160. A light source of an automated component inspection device (ACID) [covered in detail during the discussion of FIG. 8] is focus on the solder pad 152, such that the angle of incident A 170 is parallel to the line 168, thereby promoting a maximum amount of reflected light 164 to be captured by the lens 158.

FIG. 5 shows a top surface 172 of the component 142 substantially parallel to the solder pad 152. Because the top surface 172 of the component 142 is substantially parallel to the solder pad 152, the reflected light 164 reflected off of the top surface 172 is substantially parallel to the line 168. The reflected light 164 reflecting off of the meniscus 146 of the solder joint 140 is substantially non-parallel to the line 168, due to the curvature of the surface of the meniscus 146.

Because the reflected light 164 reflected off of the meniscus 146 is non-parallel to the line 168, the amount of reflected light 164 captured by the lens 158 is significantly reduced. The difference in reflected light 164 captured by the lens 158 between the solder pad 152, the meniscus 146, and the top surface 172 of the component 142 results in a difference in an intensity level of the reflected light 164 experienced by the lens 158.

Returning to FIG. 3, it is noted that the solder pad search window 156 includes a commencement edge 174 and a completion edge 176. During operation of a preferred embodiment of the present invention, analysis of the intensity level of the reflected light 164 (of FIG. 4) reflecting off of the solder pad 152, the meniscus 146, and the component edge 154 commences at the commencement edge 174, progresses through the solder pad search window 156, and concludes at the completion edge 176.

Because the angle of incident A 170 of the reflected light 164 reflecting off of the solder pad 152, is parallel to the line 168 (of FIG. 4), the intensity level of the reflected light 164 captured by the lens 158 (of FIG. 4) is significantly greater than the intensity level of the reflected light 164 reflected off of the meniscus 146.

In other words, as the analysis of the intensity level of the reflected light 164 progresses from the commencement edge 174, the intensity level of the reflected light 164 drops significantly upon encountering the meniscus 146. This change in intensity level is identified as a leading edge 178, 180 of the meniscus 146. As the analysis of the intensity level of the reflected light 164 progresses through the solder pad search window 156, a second significant change in the intensity level of the reflected light 164 occurs upon encountering the component 142, and the angle of incident of the reflected light 164 again conforms substantially to the angle of incident A 170.

That is, the reflected light 164 is again substantially parallel to the line 168 upon encountering a surface substantially parallel to the solder pad 152, which (depending on the configuration of the component 142) may be either a solder lead of the component 142, or the top surface 172 of component 142 (of FIG. 5). The second significant change in intensity level defines a trailing edge 182, 184 of the meniscus 146. The region between the leading edge 178, 180 and the trailing edge 182, 184 (because of the low intensity level of the reflected light 164 encountered during analysis of the meniscus 146) forms boundaries of a reflected light intensity transition region (also referred to herein as a shadow projection) 186, 188 illustrated as the shadowed portions of FIG. 3.

FIG. 6 shows a minimum shadow width 190 against which the shadow projection 186, 188 (of FIG. 3) of each solder joint 140 is compared to determine compliance of the component 142 (of FIG. 1) of the PCBA 130 (of FIG. 1). If each shadow projection 186, 188 of each solder joint 140 has a width determined to be greater than the minimum shadow width 190, the component 142 is compliant, and the PCBA 130 is indicated as compliant. If any shadow projection 186, 188 of each solder joint 140 has a width determined to be less than the minimum shadow width 190, the component 142 is non-compliant, and the PCBA 130 is indicated as non-compliant.

The minimum shadow width 190 is derived from an empirically determined shadow projection threshold (not separately shown). The empirically determined shadow projection threshold is determined for each component type by analyzing a plurality of known good solder joints for that component type.

Because of the physical characteristics of each component type [i.e. reflectivity of the surface (a characteristic associated with the roughness of the surface), color, and physical contour of the component] the trailing edge 182, 184 (of FIG. 3), designation of the meniscus 146 (of FIG. 3) will occur at different intensity levels between the meniscus 146 and the component edge 154 (of FIG. 3) of each component type. As such, a predetermined brightness intensity level threshold (covered in detail during the discussion of FIG. 7) is selected during analysis of the plurality of samples of each component type for each component type.

Based on the predetermined brightness intensity level threshold specific to a component type, shadow projections, for each solder joint 140 of that component type are determined from the samples of that component type. Those shadow projections are analyzed to establish the predetermined shadow projection threshold for that component type. If the shadow projection 186, 188 of the component 142 exceeds the predetermined shadow projection threshold (that is, the shadow projection is measured to be larger than the predetermined shadow projection threshold), the component 142 is identifying as non-compliant.

The solder joints of minimum acceptance are selected from the plurality of samples plurality of the known good solder joints and analyzed in view of the predetermined shadow projection threshold, to ascertain the minimum shadow width 190.

FIG. 7 shows an intensity level 192 for light provided by a light source (not separately shown) and reflecting off the solder pad 152 (of FIG. 4), which is subsequently encountered by the lens 158 (of FIG. 4). Also shown by FIG. 7 is an intensity level 194, for light reflecting off the meniscus 146 (of FIG. 5) that the lens 158 encounters. Still further shown by FIG. 7 is an intensity level 196, for light reflecting off the component edge 154 (of FIG. 3) that the lens 158 encounters.

Because of the variations in configuration and physical characteristics of various component types, the intensity levels 192, 194, and 196 are analyzed to determine a brightness intensity level threshold 198. The brightness intensity level threshold is utilized to determine at what point within the solder pad search window 156 (of FIG. 3), a change in intensity level is considered a significant change in intensity level. Significant changes in intensity levels are used to identify the leading edge 178, 180 and the trailing edge 182, 184 of the shadow projection 186, 188.

In a preferred embodiment, when the intensity level is being monitored within the solder pad search window 156, and a change of the monitored intensity level from a level above the brightness intensity level threshold 198, to a level below the brightness intensity level threshold 198, identification of a leading edge 178, 180 of the shadow projection 186, 188 occurs. When the intensity level is being monitored within the solder pad search window 156, and a change of the monitored intensity level from a level below the brightness intensity level threshold 198, to a level above the brightness intensity level threshold 198, identification of a trailing edge 182, 184 of the shadow projection 186, 188 occurs.

As recognized by those skilled in the art, the mechanical configurations of an automated component inspection device (ACID), such as ACID 200 of FIG. 8, will vary to accommodate the PCBA of a particular DSD, and the manufacturing processes selected to produce that PCBA. The mechanical presentation of the ACID 200 has been selected to add clarity and brevity in disclosing the subject matter of the invention. The selected structure is but one of multiple configurations in which numerous changes would readily suggest themselves to those skilled in the art, without changing the functionality of the ACID 200, and therefore does not impose limitations on the present invention.

FIG. 8 shows a robotic positioning arm 202 with an end-effector 204 communicating with a processor control vision system 206 and a light source 208. Both the processor control vision system 206 and the light source 208 communicate with a process controller 210 via a control cable 212. The PCBA 130 is transported by a conveyor 214 beneath the vision system 206 for compliant inspection.

Upon completion of compliance inspection by ACID 200, the conveyor 214 transports that PCBA 130 from beneath the vision system 206, and conveys a subsequent PCBA 130 into alignment with the vision system 206. Operational control of the vision system 206 by the process controller 210 is accommodated by a vision system control cable 216, while control of the light source 208 is accommodated by a light source control cable 218.

The ACID 200 also supports a station controller 220 that communicates with a factory control system (not separately shown) to report identified instances of non-compliance for any PCBA 130 found to be non-compliant.

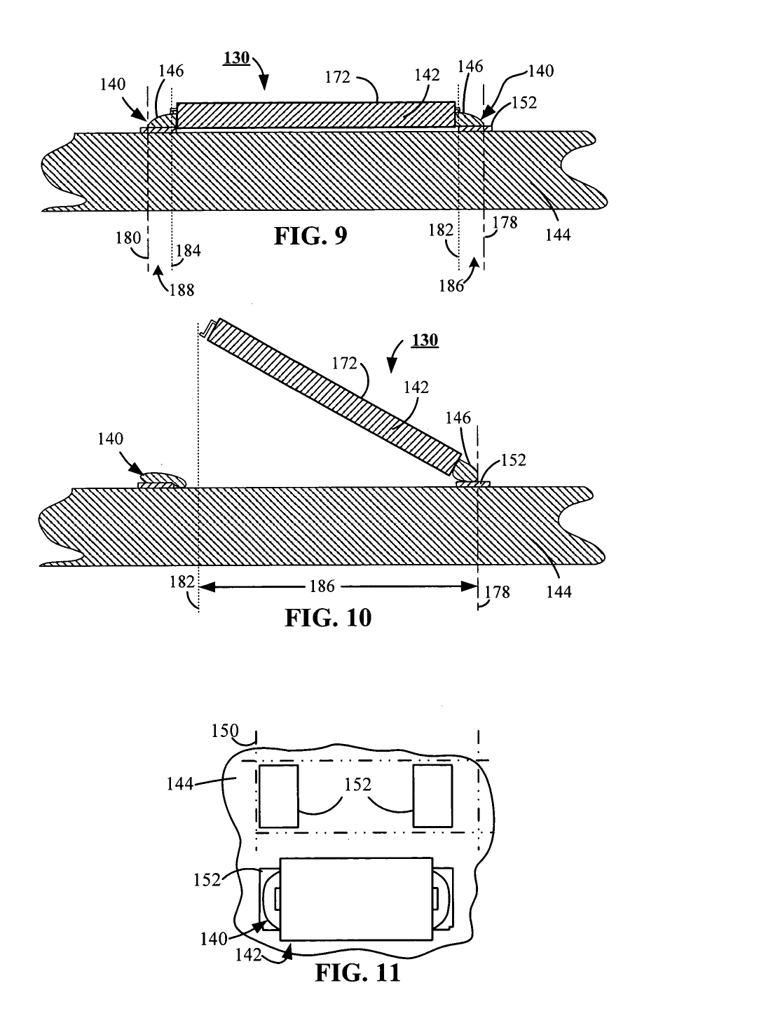

FIG. 9 shows each shadow projection 186, 188 of each meniscus 146 of each solder joint 140 adhering to a state of being greater than the minimum shadow width 190 (of FIG. 6). Because each shadow projection 186, 188 are greater than the minimum shadow width 190, the component 142 is a compliant component and PCBA 130 is a compliant PCBA.

FIG. 10 illustrates a non-compliant component 142 with a condition referred to as a “tombstone defect.” As component sizes continue to shrink, tombstone defects become more difficult to optically identify.

In a preferred embodiment, tombstone defects are readily identified by the present invention. While analyzing for compliance within the solder pad search window 156 (of FIG. 3), a significant change in intensity level identifying the leading edge 178 of the shadow projection 186 will be identified. However, the trailing edge 182 of the shadow projection 186 will occur outside the solder pad search window 156 by a substantial amount.

Delayed occurrence of the trailing edge 182 occurs because, the incident angle of reflection of reflected light 164 reflecting off of the sloped top surface 172 precludes the reflected light 164 from being substantially parallel to the line 168 (of FIG. 4), thereby minimizing the amount of reflected light 164 captured by the lens 158 (of FIG. 8) of the vision system 206 (of FIG. 8). Because the shadow projection 186 is non-compliant, the component 142 is flagged as a non-compliant component, and PCBA 130 is identified as a non-compliant PCBA.

FIG. 11 shows a pair of solder pads 152 absent an associated component 142, and a pair of solder pads 152 associated with the component 142. As a contingency, PCBA designers commonly add blank or dummy solder pads 152 to the board 144 circuitry, for rework to correct unforeseen circuit problems or, for improving the PCBA circuit design.

In a preferred embodiment of the present invention, blank or dummy solder pads 152, as well as components missing from the component site 150 are readily identified. If the shadow projection 186, 188 (of FIG. 3) is less than the minimum shadow width 190 (of FIG. 6), the region of the board 144 identified by the component site 150 is flagged as having a missing component. If the component site 150 is intended to be a portion of the board 144 absent a component, and no component is present, the PCBA 130 will be identified as a compliant PCBA.

FIG. 12 shows a component compliance determination method 300, for determining compliance of a component (such as 142) of a PCBA (such as 130) commencing at start step 302, and continuing a process step 304. At process step 304, a component site (such as 150) is selected, for a region of a printed circuit board (such as 144) that supports a plurality of solder pads (such as 152) in preparation, for analysis of compliance by a component associated with the plurality of solder pads. At process step 306, a determination of whether or not a component is present within component site is made. If the component is present the process continues to process step 308. At process 308, a determination of whether or not the component present should be present or should not be present is made. If the determination is made that the component should be present, the process continues to process step 310.

At process step 310, a component footprint (such as 148) is utilized for comparison with the component that is present to determine whether or not the component that is present is a proper component. At process step 312, a determination of whether or not the component present within the component site is in compliance with the component footprint is made. If compliance between the component present and the component footprint exists, the process continues to process step 314. At process step 314, a reflected light intensity transition region (also referred to as a shadow projection such as 186, 188) is determined, for each solder pad of the component by analyzing reflected light intensity readings (such as shown by FIG. 7) of reflected light (such as 164) within the solder pad search window (such as 156).

At process step 316, a minimum shadow width (such as 190) associated with the component is selected, for use in determining compliance of the component. Component compliance is based on comparison between the determined shadow projection and the minimum shadow width. At process step 318, the comparison is made between each shadow projection and the minimum shadow width. At process step 320, determinations are made as to whether or not any of the shadow projections are less than the selected minimum shadow width. If none of the shadow projections are less than the minimum shadow width, the process continues to process step 322.

At process step 322, a determination is made regarding which sites of the board supporting components remain for analysis. If no sites remain, the process continues to process step 324, with identification of the PCBA as a compliant PCBA, and continues to end process step 326, with a conclusion of the component compliance determination method 300. If sites of the board remain for analysis, the process reverts to process step 304 and selects the component site for analysis.

The process continues to process step 306 with a determination of whether or not a component is present. If no component is present, the process continues to process step 328 with a determination of whether or not a component should be present. If no component should be present the process continues to process step 304, with selection of a component site for compliance checking. However, if a determination is made at process step 328 that a component is not present, and should be present, the process proceeds to process step 330, which identifies the PCBA 130 as a non-compliant PCBA, and continues to end process step 326, with the conclusion of the component compliance determination method 300.

At process step 308, if the determination is made that the component present should not be present, the process proceeds to process step 330, which identifies the PCBA 130 as a non-compliant PCBA, and continues to end process step 326, with the conclusion of the component compliance determination method 300. At process step 312, if the determination is made that component present is not in compliance with the component footprint, the process proceeds to process step 330, which identifies the PCBA 130 as a non-compliant PCBA, and continues to end process step 326, with the conclusion of the component compliance determination method 300.

In making the determination of whether or not any of the shadow projections associated with the component undergoing compliance verification at process step 320, if any shadow projections are found to be less than the selected minimum shadow width, the process proceeds to process step 330, which identifies the PCBA 130 as a non-compliant PCBA, and continues to end process step 326, with the conclusion of the component compliance determination method 300.

Accordingly, in preferred embodiments, the present invention is directed to a method (such as 300), for determining compliance of a component (such as 142) that incorporates an electronic comparison of a reflected light intensity transition region [also referred to as a shadow projection (such as 186, 188)], with a predetermined reflected light intensity transition region threshold [also referred to as a minimum shadow width (such as 190)], to determine compliance of the component of a printed circuit board (such as 144), of a printed circuit board assembly (such as PCBA 130).

The preferred embodiments further includes, an apparatus (such as ACID 200), for determining compliance of the printed circuit board assembly based on compliance of the component connected to the printed circuit board assembly by a solder joint (such as 140). The compliance determination apparatus includes: a light source (such as 208) illuminating the component of the printed circuit board assembly, as well as the solder joint connecting the component to the printed circuit board assembly; a processor controlled vision system (such as 206) responsive to the light source; an alignment apparatus (such as robotic positioning arm 202) controlled by a processor (such as 210) supporting the vision system. The alignment apparatus aligns the vision system relative to the solder joint and the component.

The compliant determination apparatus further includes, decision software programmed into the processor, responsive to the vision system determining compliance of the component connected to the printed circuit board assembly, based on the shadow projection of the solder joint to determine compliance of the printed circuit board assembly.

The preferred embodiments of present invention further include, a data storage device (such as 100) having a head-disc assembly (such as 106), and a compliant printed circuit board assembly (such as 130) attached to the head-disc assembly. Compliance of the printed circuit board assembly is determined by the compliance determination apparatus executing the method for determining compliance of the component connected to the printed circuit board assembly.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the number of component leads of components utilized by a PCBA varies depending on the types of components utilized to achieve the desired function of the PCBA. Printed circuit board assemblies utilizing a plurality of component types, wherein each component type supports a plurality of component leads, fall within the scope and spirit of the present invention. In addition, although the preferred embodiment described herein is directed to component compliance determination for PCBAs for a data storage device, it will be appreciated by those skilled in the art that the teachings of the present invention can be applied to other applications involving solder components without departing from the scope and spirit of the present invention.

1. A method by steps comprising comparing electronically a reflected light intensity transition region with a predetermined reflected light intensity transition region threshold to determine compliance of a component.

2. The method of claim 1, in which the component is connected to a printed circuit board assembly, and in which the reflected light intensity transition region is an intensity of light reflected off a meniscus of a solder joint formed between the component and an associated solder pad of the printed circuit board assembly, wherein the steps further comprising:
ascertaining a status of the component at a predetermined component site of the printed circuit board assembly;
characterizing adherence of the intensity of light reflected off the meniscus to the predetermined light intensity transition region threshold; and
determining compliance of the component connected to the printed circuit board assembly based on the characterization of the adherence of the intensity of light reflected off the meniscus to the threshold.

3. The method of claim 2, in which the status of the component at the predetermined component site of the printed circuit board assembly is a presence status, wherein the method proceeds to the characterizing step when the component present substantially conforms to a predetermined component footprint.

4. The method of claim 3, in which the step of characterizing adherence of the intensity of light reflected off the meniscus to the threshold comprises:
associating a solder pad search window to the predetermined component footprint;
identifying a leading edge of the meniscus of the solder joint within the solder pad search window;
isolating a trailing edge of the meniscus of the solder joint;
determining the intensity of light reflected off the meniscus is a shadow projection of the meniscus of the solder joint based on a relationship between the leading and trailing edges of the meniscus of the solder joint; and
comparing the shadow projection with the predetermined reflected light intensity transition region threshold to characterize the meniscus of the solder joint, wherein the predetermined reflected light intensity transition region threshold is a predetermined shadow projection threshold.

5. The method of claim 4, in which the predetermined shadow projection threshold is a minimum shadow width, wherein the shadow projection exceeds the minimum shadow width, and in which the determining step determines the component is compliant based on the shadow projection exceeding the minimum shadow width.

6. The method of claim 4, in which the predetermined shadow projection threshold is a minimum shadow width, wherein the shadow projection fails to exceed the minimum shadow width, and in which the determining step determines the component is non-compliant based on the shadow projection failing to exceed the minimum shadow width.

7. The method of claim 2, in which the status of the component at the predetermined component site of the printed circuit board assembly is a presence status, wherein the method proceeds to the determining step when the component present fails to substantially conform with a predetermined component footprint, wherein the determining step determines the component to be non-compliant and identifies the printed circuit board assembly as a non-compliant printed circuit board assembly.

8. The method of claim 2, in which the status of the component at the predetermined component site of the printed circuit board assembly is a non-presence status, wherein the determining step determines the non-presence status of the component to be compliant and identifies the printed circuit board assembly as a compliant printed circuit board assembly.

9. The method of claim 2, in which the status of the component at the predetermined component site of the printed circuit board assembly is a non-presence status, wherein the determining step determines the non-presence status of the component to be non-compliant and identifies the printed circuit board assembly as a non-compliant printed circuit board assembly.

10. The method of claim 3, in which the meniscus of the solder joint is characterized as missing by the characterizing step, and in which the determination step determines the missing meniscus to be a non-compliant component and identifies the printed circuit board assembly as a non-compliant printed circuit board assembly.

11. The method of claim 4, in which the leading edge of the meniscus of the solder joint is identified by steps comprising:
illuminating the printed circuit board assembly with a light source;
focusing a vision system across the solder pad search window;
measuring a brightness intensity level of a reflected light reflected off the solder pad from the light source;
determining a brightness intensity level of the reflected light reflected off the meniscus of the solder joint from the light source; and
analyzing the brightness intensity level of the light reflected off the meniscus of the solder joint relative to the brightness intensity level of the light reflected off the solder pad to ascertain the leading edge of the meniscus of the solder joint.

12. The method of claim 11, in which the brightness intensity level of the light reflected off the meniscus of the solder joint is less than the brightness intensity level of the light reflected off the solder pad.

13. The method of claim 12, in which the measured brightness intensity level of the light reflected off the solder pad is greater than a predetermined brightness intensity level threshold.

14. The method of claim 13, in which the measured brightness intensity level of the light reflected off the meniscus of the solder joint is less than the predetermined brightness intensity level threshold.

15. The method of claim 11, in which the solder pad has a substantially flat surface, the vision system includes a lens with a flat surface and a curved surface, wherein the curved surface includes a center of curvature, and wherein a line normal to the flat surface of the lens and passing through the center of curvature of the lens is substantially parallel with an angle of incidence of the light reflected from the substantially flat surface of the solder pad.

16. The method of claim 15, in which the component has a substantially flat surface, wherein the line normal to the flat surface of the lens and passing through the center of curvature of the lens is substantially parallel with an angle of incidence of the light reflected from the substantially flat surface of the component.

17. The method of claim 16, in which the meniscus of the solder joint has a substantially curved surface, wherein the line normal to the flat surface of the lens and passing through the center of curvature of the lens is substantially non-parallel with an angle of incidence of the light reflected from the substantially curved surface of the meniscus of the solder joint.

18. The method of claim 17, in which the substantially non-parallel angle of incidence of the light reflected off the meniscus of the solder joint relative to the line contrasted with, the substantially parallel angle of incidence of the light reflected off the solder pad and the component relative to the line provides the shadow projection.

19. The method of claim 5, in which the determining step determines the printed circuit board assembly as a compliant printed circuit board assembly based on the determination that the component is compliant.

20. The method of claim 6, in which the determining step determines the printed circuit board assembly as a non-compliant printed circuit board assembly based on the determination that the component is non-compliant.

21. An apparatus for determining compliance of a printed circuit board assembly based on compliance of a component connected to the printed circuit board assembly by a solder joint comprising:
a light source illuminating the component of the printed circuit board assembly as well as the solder joint connecting the component to the printed circuit board assembly;
a processor controlled vision system responsive to the light source;
an alignment apparatus controlled by a processor supporting the vision system, the alignment apparatus aligning the vision system relative to the solder joint and the component; and
decision software programmed into the processor responsive to the vision system determining compliance of the component connected to the printed circuit board assembly based on a shadow projection of the solder joint to determine compliance of the printed circuit board assembly.

22. A data storage device comprising:
a head-disc assembly; and
a compliant printed circuit board assembly attached to the head-disc assembly, compliance of the printed circuit board assembly determined by means for determining compliance of a printed circuit board assembly through steps for determining compliance of a component connected to a printed circuit board assembly.

23. The data storage device of claim 22, in which the means for determining compliance of a printed circuit board assembly comprises:
a light source illuminating the component of the printed circuit board assembly as well as the solder joint connecting the component to the printed circuit board assembly;
a processor controlled vision system responsive to the light source;
an alignment apparatus controlled by a processor supporting the vision system, the alignment apparatus aligning the vision system relative to the solder joint and the component; and
decision software programmed into the processor responsive to the vision system determining compliance of the component connected to the printed circuit board assembly based on a shadow projection of the solder joint to determine compliance of the printed circuit board assembly.

24. The data storage device of claim 22, in which the steps for determining compliance of a component connected to a printed circuit board assembly comprise:
ascertaining a status of the component at a predetermined component site of the printed circuit board assembly;
comparing electronically a reflected light intensity transition region with a predetermined reflected light intensity transition region threshold, wherein the reflected light intensity transition region is an intensity of light reflected off a meniscus of a solder joint formed between the component and an associated solder pad of the printed circuit board assembly;
characterizing adherence of the intensity of light reflected off the meniscus to the threshold; and
determining compliance of the component connected to the printed circuit board assembly based on the characterization of the adherence of the intensity of light reflected off the meniscus to the threshold.
